(19) United States
(12) Patent Application Publication
(10) Pub. No.: US 2026/0238068 A1
(43) Pub. Date: Aug. 13, 2026

(54) MOTOR FOR VACUUM CLEANER

(71) Applicant: NEW MOTECH CO., LTD., Gwangju (KR)

(72) Inventors: Jeong Cheol JANG, Gwangju (KR); Gyeong Su PARK, Gwangju (KR); Gyeong Sik YANG, Gwangju (KR); Kwang Deok SEO, Gwangju (KR)

(73) Assignee: NEW MOTECH CO., LTD., Gwangju (KR)

(21) Appl. No.: 19/164,220

(22) PCT Filed: Mar. 13, 2024
(86) PCT No.: PCT/KR2024/003252

§ 371 Date: Sep. 11, 2025

(30) Foreign Application Priority Data
Mar. 16, 2023 (KR) 10-2023-0034800

(51) Int. Cl. H02K 5/16; H02K 9/06

(52) U.S. Cl. CPC H02K 5/161; H02K 9/06

(57) ABSTRACT

A motor for a vacuum cleaner according to the present invention comprises: a motor housing 10 formed by subjecting a stator assembly 20 to insert injection, and made by bulk molding compound (BMC) molding having a hollow portion 11 into which a shaft 31 including a rotor assembly 30 is inserted; and an annular cooling unit 100 formed by outwardly extending around an upper outer circumference of the motor housing 10, wherein an upper bearing 50 inserted into an upper part of the shaft 31 is press-fitted into an upper bearing accommodating portion 14 of the motor housing 10, and a lower bearing 40 inserted into a lower part of the shaft 31 is seated in a lower bearing accommodating portion 15.

### TECHNICAL FIELD

The present invention relates to a motor for a vacuum cleaner. More specifically, the present invention relates to a motor for a vacuum cleaner capable of improving productivity of a motor and reducing the cost of manufacturing a motor by shortening the assembly process of the motor and leaving out the assembly parts by providing a motor housing formed by bulk molding compound (BMC) molding by subjecting a stator assembly to insert injection.

### BACKGROUND ART

In general, a motor may be used in various home appliances. Especially, a motor used in a vacuum cleaner, etc. is a device which obtains a rotational force from electric energy, and includes a stator and a rotor. The rotor is configured to electromagnetically interacte with the stator, and rotates through the force applied by a magnetic field generated by a current flowing into a coil.

As prior art relating to a motor for a vacuum cleaner, Korean Patent No. 10-2482007 discloses “motor assembly and cleaner having the same.”

In the prior art, a motor housing is assembled by arranging a stator assembly between an upper housing and a lower housing, and then coupling the upper and lower housings with a separate assembly bolt, but the motor housing is assembled through a process in which the upper and lower bearings are adhered to the upper and lower housings with an adhesive for fixation, which not only lengthens the assembly process, but also reduces the productivity of the motor due to an increase in the number of assembly parts, increases the cost of manufacturing the motor, and reduces the reliability due to a decrease in the quality of the motor due to a weak stable fix-coupling of the bearings.

Accordingly, the present invention aims to improve the above-mentioned problems and provide a new type of motor for a vacuum cleaner which has the upper and lower housing integrally formed.

### DISCLOSURE OF INVENTION

### Technical Problem

It is an object of the present invention to provide a motor for a vacuum cleaner in which one motor housing is provided using BMC molding without distinguishing between upper and lower housings, thereby shortening the assembly process for coupling the upper and lower housings, as well as leaving out the number of parts for the assembly while preventing the deviation of bearings which promote smooth rotation of the shaft.

The above and other inherent objects of the present invention may all be easily achieved by the description of the present invention described below.

### Solution to Problem

A motor for a vacuum cleaner according to the present invention, comprises: a motor housing 10 formed by subjecting a stator assembly 20 to insert injection, and made by bulk molding compound (BMC) molding having a hollow portion 11 into which a shaft 31 including a rotor assembly 30 is inserted; and an annular cooling unit 100 formed by outwardly extending around an upper outer circumference of the motor housing 10, wherein an upper bearing 50 inserted into an upper part of the shaft 31 is press-fitted into an upper bearing accommodating portion 14 of the motor housing 10, and a lower bearing 40 inserted into a lower part of the shaft 31 is seated in a lower bearing accommodating portion 15.

In the present invention, the cooling unit 100 may have a plurality of air guiding blade pieces 120 arranged at a certain interval in a space portion S between an upper circumferential portion 12 of the motor hosing 10 and an outer annular frame 110 so that the upper circumferential portion 12 of the motor housing 10 and the outer annular frame 110 are integrally connected by the air guiding blade piece 120, and each of the air guiding blade pieces 120 is arranged in an inclined state.

In the present invention, upper and lower bearing accommodating portions 14, 15 may be formed in the upper part and lower part of the motor housing 10, a support annular jaw 14A may be formed in a lower circumference of the upper bearing accommodating portion 14, and a bearing departure preventing annular jaw 15A may be formed in a lower outer circumference of the lower bearing accommodating portion 15.

In the present invention, an elastic annular groove 140 may be formed in an upper outer circumference of the upper bearing accommodating portion 14 of the motor housing 10, and an inclined engagement guiding annular jaw 141 may be formed in an upper inner circumference of the elastic annular groove 140.

In the present invention, an annular projection 14B may be formed in an inner circumference of the upper bearing accommodating portion 14, and a departure preventing recess 14B′ may be formed in a surface of the annular projection 14B.

### Advantageous Effects of Invention

The present invention provides a motor housing made by BMC molding which integrally accommodates the stator assembly without upper and lower housings, and has an effect of shortening the assembly time of the motor, and improving the productivity by reducing the number of assembly parts, thereby reducing the cost of manufacturing the motor.

In addition, the present invention has an effect of improving the quality of the motor by press-fitting and fixing an upper bearing installed in the shaft into an upper bearing accommodating portion of the motor housing, and at the same time, seating a lower bearing in a lower bearing accommodating portion of the motor housing so as to prevent the bearing from deviating, thereby improving reliability.

### BRIEF DESCRIPTION OF DRAWINGS

FIG. 1 is a top overall assembled perspective view illustrating a motor for a vacuum cleaner according to the present invention;

FIG. 2 is a bottom overall assembled perspective view illustrating a motor for a vacuum cleaner according to the present invention;

FIG. 3 is an exploded perspective view from which a motor for a vacuum cleaner according to the present invention is separated;

FIG. 4 is a cross-sectional perspective view illustrating a motor for a vacuum cleaner according to the present invention cut away through a mid-section;

FIG. 5 is an exploded cross-sectional view illustrating a motor for a vacuum cleaner according to the present invention;

FIG. 6 is an overall longitudinal cross-sectional view illustrating a motor for a vacuum cleaner according to the present invention; and

FIG. 7 is a partially enlarged cross-sectional view illustrating a motor for a vacuum cleaner according to another embodiment of the present invention.

Hereinafter, the present invention will be described in detail with reference to the ac-companying drawings.

### MODE FOR THE INVENTION

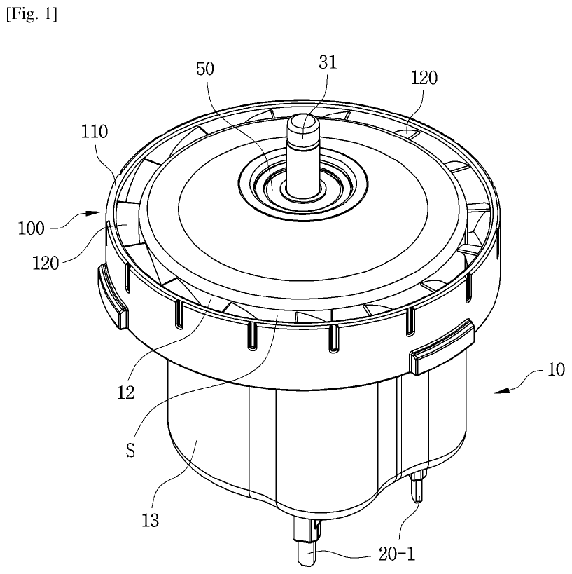

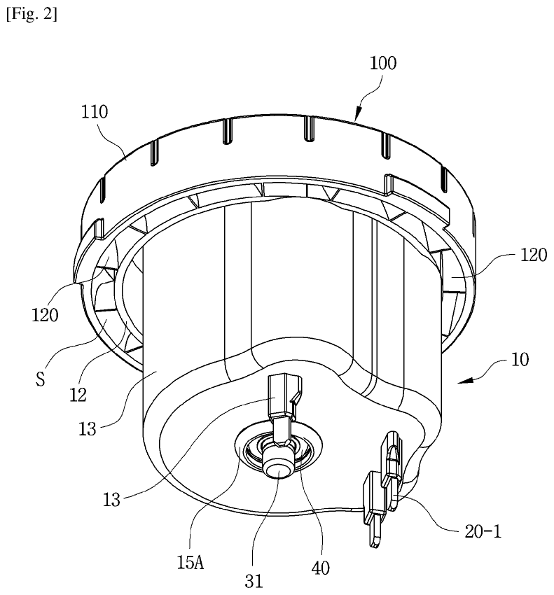

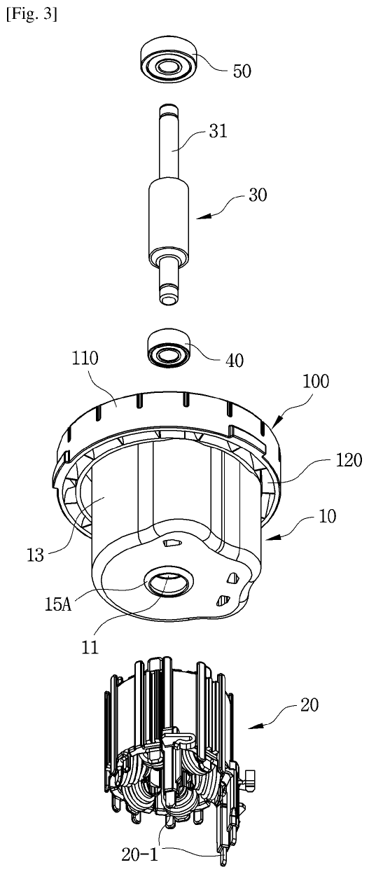

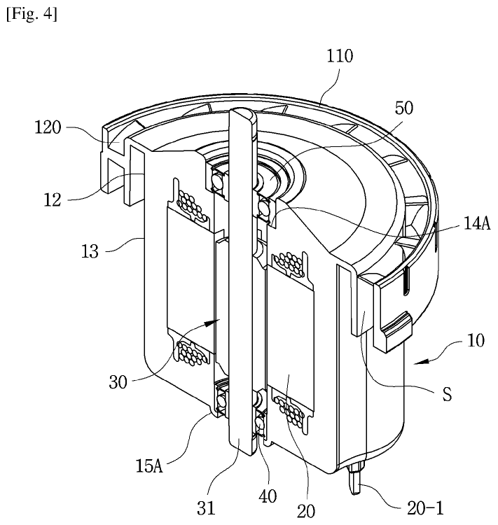

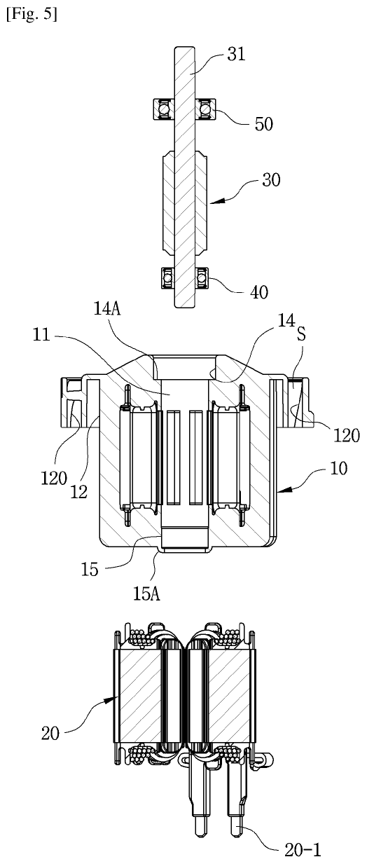

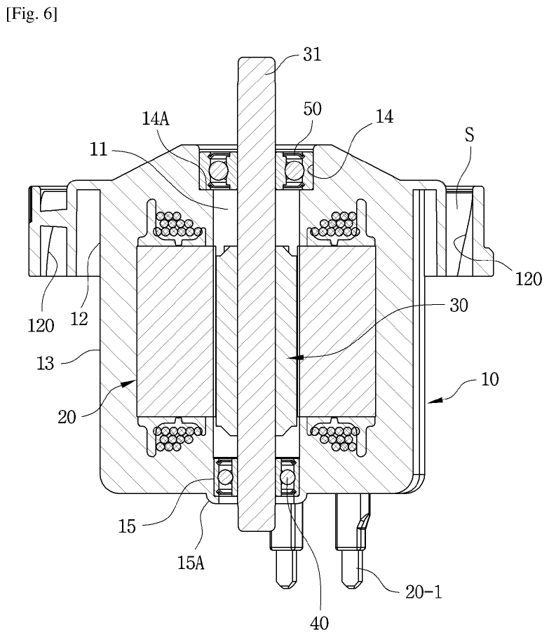

FIG. 1 is a top overall assembled perspective view illustrating a motor for a vacuum cleaner according to the present invention. FIG. 2 is a bottom overall assembled perspective view illustrating a motor for a vacuum cleaner according to the present invention. FIG. 3 is an exploded perspective view from which a motor for a vacuum cleaner according to the present invention is separated. FIG. 4 is a cross-sectional perspective view illustrating a motor for a vacuum cleaner according to the present invention cut away through a mid-section. FIG. 5 is an exploded cross-sectional view illustrating a motor for a vacuum cleaner according to the present invention. FIG. 6 is an overall longitudinal cross-sectional view illustrating a motor for a vacuum cleaner according to the present invention.

As illustrated in FIGS. 1 to 6, a motor for a vacuum cleaner according to the present invention comprises a motor housing 10, a stator assembly 20, and a rotor assembly 30.

The motor housing 10 is formed by insert injection which performs injection molding while locating the stator assembly 20 in a mold. Accordingly, the motor housing 10 is made by a BMC-like resin molding which accommodates the stator assembly 20 therein. The resin molding (hereinafter, referred to as “BMC molding”) has a hollow portion 11 into which a shaft 31 including a rotor assembly 30 is inserted on an inner side of the motor housing 10. Additionally, the motor housing 10 may include an annular cooling unit 100 formed by outwardly extending around an upper outer circumference of the motor housing 10. A power connection terminal 20-1 protrudes from a lower part of the motor housing 10.

The present invention provides a motor housing 10 made by BMC molding that is integrally formed without separate upper and lower housings and accommodates the stator assembly 20, thereby shortening the assembly time of the motor, improving the productivity by reducing the number of assembly parts such as assembly bolts, etc., and reducing the cost of manufacturing the motor.

The cooling unit 100 may have a plurality of air guiding blade pieces 120 arranged at a certain interval in a space portion S between an upper circumferential portion 12 of the motor hosing 10 and an outer annular frame 110 so that the upper circumferential portion 12 of the motor housing 10 and the outer annular frame 110 are integrally connected by the air guiding blade piece 120, and each of the air guiding blade pieces 120 is arranged in an inclined state.

The annular cooling unit 100 with such configuration may improve the motor efficiency as the air inhaled when an impeller (not shown) coupled to a shaft 31, which will be mentioned later, rotates flows into the space portion S between the upper circumferential portion 12 of the motor housing 10 and the outer annular frame 110, and is discharged downwardly of the annular cooling unit 100 in the form of a whirlwind by the inclined air guiding blade piece 120, allowing the air to be supplied to an outer circumferential surface 13 of the motor housing 10, and the heat generated from the stator assembly 20 inside the motor housing 10 to be cooled.

Furthermore, upper and lower bearing accommodating portions 14 15 are formed in an upper part and a lower part of the motor housing 10, respectively. A support annular jaw 14A may be formed in a lower circumference of the upper bearing accommodating portion 14, and a bearing departure preventing annular jaw 15A may be formed in a lower outer circumference of the lower bearing accommodating portion 15.

The lower bearing 40 installed in a lower part of the shaft 31 inserted into a hollow portion 11 of the motor housing 10 is fitted into the lower bearing accommodating portion 15, and a lower outer circumferential surface of the lower bearing 40 is arranged in an inner circumference of the bearing departure preventing annular jaw 15A of the lower bearing accommodating portion 15 so that the lower bearing 40 can be installed not to deviate outwardly.

The upper bearing 50 installed in an upper part of the shaft 31 is forcibly press-fitted into the upper bearing accommodating portion 14, and the upper bearing 50 is maintained to be press-fitted by allowing a lower outer circumferential surface of the upper bearing 50 to be seated in an upper circumferential surface of the support annular jaw 14A of the upper bearing accommodating portion 14, so that the upper bearing 50 can be maintained in a solid state without deviating to the upper part of the motor housing 10.

The motor housing 10 is molded by BMC molding, which enables a forced press-fit due to the nature of material of the BMC molding when press-fitting the upper bearing 50 into the upper bearing accommodating portion 14. The press-fit operation of the upper bearing 50 may press-fit the upper bearing into the upper bearing accommodating portion 14 by force through an additional press-fitting jig.

The present invention with such configuration prevents the upper bearing 50 and lower bearing 50, which promote smooth rotation of the shaft 31, from deviating, thereby improving the quality of the motor and securing reliability thereof.

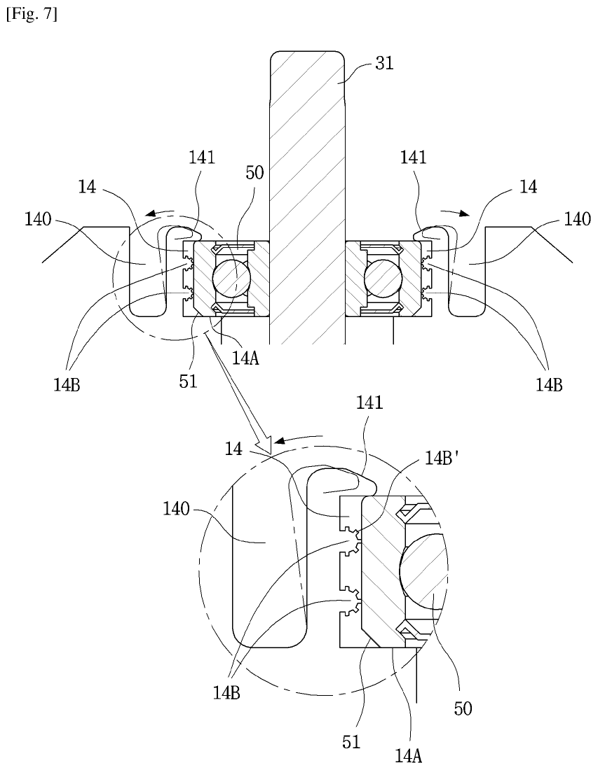

FIG. 7 is a partially enlarged cross-sectional view illustrating a motor for a vacuum cleaner according to another embodiment of the present invention.

According to FIG. 7, an elastic annular groove 140 is formed in an upper outer circumference of the upper bearing accommodating portion 14 of the motor housing 10, and an inclined engagement guiding annular jaw 141 is formed in an upper inner circumference of the elastic annular groove 140. When press-fitting an upper bearing 50 into an upper bearing accommodating portion 14, the upper bearing is guided downwardly along the inner circumference of the inclined engagement guiding annular jaw 141 so that the elastic annular groove 140 can be elastically narrowed and the upper bearing 50 can be smoothly inserted into and seated in the upper bearing accommodating portion 14.

When the upper bearing 50 is fitted into the inner circumference of the upper bearing accommodating portion 14, as the elastically narrowed elastic annular groove 140 returns to its original state, the upper outer circumferential surface (an upper outer circumferential surface of an outer ring) of the upper bearing 50 is in surface-contact with the lower circumference of the inclined engagement guiding annular jaw 141, and accordingly, the upper bearing 50 is elastically seated in the upper bearing accommodating portion 14, thereby preventing the upper bearing 50 and lower bearing 40, which promote smooth rotation of the shaft 31 when driving the motor, from deviating.

An annular projection 14B may be formed in an inner circumference of the upper bearing accommodating portion 14, and a departure preventing recess (14B′) may be formed in a surface of the annular projection 14B.

In the lower outer circumference of the upper bearing 50 (a lower outer circumference of an outer ring), an inclined surface 51 is formed so that the upper bearing 50 can be smoothly guided to the inclined engagement guiding annular jaw 141 when it is press-fitted into the upper bearing accommodating portion 14.

Such annular projection 14B strongly presses the outer circumference (outer ring) of the upper bearing 50, while the upper bearing 50 is elastically seated inside the upper bearing 50 by the elastic annular groove 140 so that a more solid seating can be made. Accordingly, the upper bearing 50 is maintained to be coupled in a solid state without shaking, and thus the noise and vibration caused by the flow of the upper bearing 50 can be suppressed.

Additionally, the departure preventing recess 14B′ allows the upper bearing 50, which tends to deviate upwardly when the shaft 31 rotates, to be maintained to be coupled in a more solid state, thereby improving the departure preventing ability of the upper bearing 50 and increasing the reliability of the motor.

It should be noted that the description of the present invention described above is merely an example for understanding the present invention, and is not intended to limit the scope of the present invention. It should be construed that the scope of the present invention is defined by the appended claims, and all modifications and alternations of the present invention fall within the protection scope of the present invention.

1. A motor for a vacuum cleaner, comprising:
a motor housing 10 formed by subjecting a stator assembly 20 to insert injection, and made by bulk molding compound (BMC) molding having a hollow portion 11 into which a shaft 31 including a rotor assembly 30 is inserted; and
an annular cooling unit 100 formed by outwardly extending around an upper outer circumference of the motor housing 10,
wherein an upper bearing 50 inserted into an upper part of the shaft 31 is press-fitted into an upper bearing accommodating portion 14 of the motor housing 10, and a lower bearing 40 inserted into a lower part of the shaft 31 is seated in a lower bearing accommodating portion 15.

2. The motor according to claim 1, wherein the cooling unit 100 has a plurality of air guiding blade pieces 120 arranged at a certain interval in a space portion S between an upper circumferential portion 12 of the motor hosing 10 and an outer annular frame 110 so that the upper circumferential portion 12 of the motor housing 10 and the outer annular frame 110 are integrally connected by the air guiding blade piece 120, and each of the air guiding blade pieces 120 is arranged in an inclined state.

3. The motor according to claim 1, wherein upper and lower bearing accommodating portions 14, 15 are formed in the upper part and lower part of the motor housing 10, a support annular jaw 14A is formed in a lower circumference of the upper bearing accommodating portion 14, and a bearing departure preventing annular jaw 15A is formed in a lower outer circumference of the lower bearing accommodating portion 15.

4. The motor according to claim 1, wherein an elastic annular groove 140 is formed in an upper outer circumference of the upper bearing accommodating portion 14 of the motor housing 10, and an inclined engagement guiding annular jaw 141 is formed in an upper inner circumference of the elastic annular groove 140.

5. The motor according to claim 1, wherein an annular projection 14B is formed in an inner circumference of the upper bearing accommodating portion 14, and a departure preventing recess 14B′ is formed in a surface of the annular projection 14B.

6. The motor according to claim 4, wherein an annular projection 14B is formed in an inner circumference of the upper bearing accommodating portion 14, and a departure preventing recess 14B′ is formed in a surface of the annular projection 14B.
